(19) United States
(12) Patent Application Publication
(10) Pub. No.: US 2016/0184969 A1
(43) Pub. Date: Jun. 30, 2016

(54) ABRASIVE ARTICLE AND METHOD FOR MAKING SAME

(71) Applicants: SHENZHEN FUTAIHONG PRECISION INDUSTRY CO., LTD., Shenzhen (CN); FIH (HONG KONG) LIMITED, Kowloon (HK)

(72) Inventors: XIAO-KAI LIU, Shenzhen (CN); CHANG-HAI GU, Shenzhen (CN); CHAO-HSUN LIN, New Taipei (TW); WEI-BEN CHEN, New Taipei (TW); BO LI, Shenzhen (CN)

(21) Appl. No.: 14/607,528

(22) Filed: Jan. 28, 2015

(30) Foreign Application Priority Data
Dec. 24, 2014 (CN) 201410811088.5

(51) Int. Cl. B24C 11/00; B24D 3/22; C09K 3/14; B24D 3/28

(52) U.S. Cl. CPC B24C 11/00; B24D 3/28; B24D 3/22; C09K 3/1436

(57) ABSTRACT

An abrasive article includes a non-rigid carrier and a plurality of abrasive particles disposed in the carrier, the carrier is made of resin or rubber, a mass ratio of abrasive particles to carrier is about 1:1 to about 5:1. A method for making the abrasive articles includes providing a plurality of abrasive particles and a resin, mixing the rubber and the abrasive particles, heating the mixture to a fluid state, and pressing the mixture into a desired shape. After the mixed is cooled, the mixture is cut into small pellets, forming the abrasive articles.

### FIELD

The present disclosure generally relates to surface treatment processes.

### BACKGROUND

Abrasive articles are often blasted onto a surface of a product to remove defects of the product. If the hardness of the abrasive articles is high, the abrasive articles may damage the product.

### BRIEF DESCRIPTION OF THE FIGURES

Implementations of the present technology will now be described, by way of example only, with reference to the attached figures.

FIG. 1 is an isometric view of an abrasive article, according to an exemplary embodiment.

FIG. 2 is a cross-sectional view of the abrasive article along line II-II of FIG. 1.

FIG. 3 is a flow chart of a method for making the abrasive article in accordance with a first exemplary embodiment.

FIG. 4 is a flow chart of a method for making the abrasive article in accordance with a second exemplary embodiment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “comprising” when utilized, means “including, but not necessarily limited to”; it specifically indicates open-ended inclusion or membership in the so-described combination, group, series, and the like.

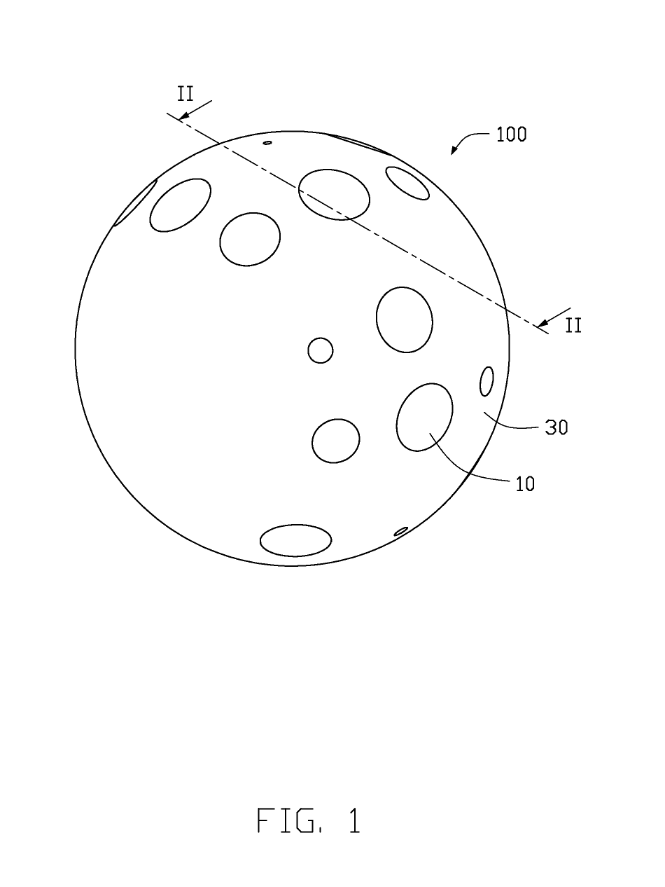

FIG. 1 illustrates an abrasive article 100 according to an exemplary embodiment. The abrasive article 100 can have good elasticity, and can be used in blasting and grinding applications. In at least one exemplary embodiment, the abrasive article 100 is ball shaped, and has a diameter of between about 0.2 mm to about 1.0 mm.

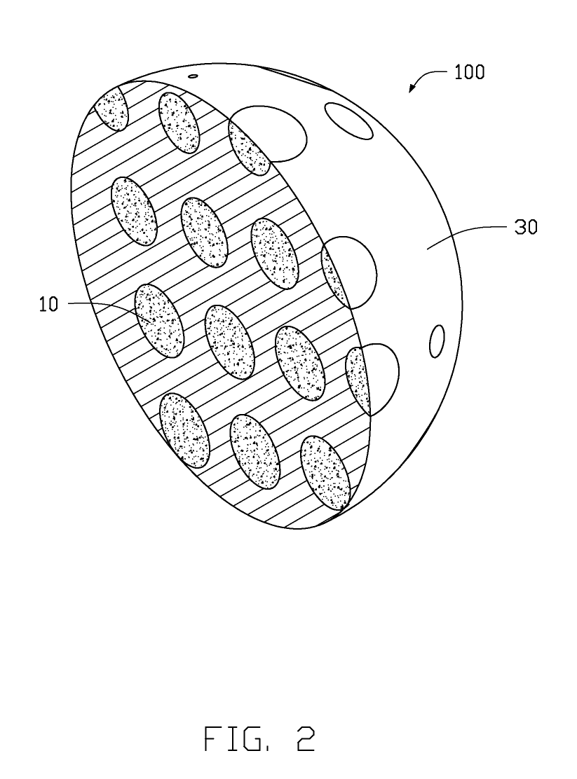

The abrasive article 100 includes a plurality of abrasive particles 10 and a carrier 30, the abrasive particles 10 can be disposed in or on the carrier 30. A mass ratio of abrasive particles 10 to carrier 30 can be about 1:1 to about 5:1. In at least one exemplary embodiment, FIG. 2 illustrates that the carrier 30 can receive a plurality of abrasive particles 10.

The abrasive particles 10 can be selected from a group consisting of alumina sand, white fused alumina sand, brown alumina sand, emery, carborundum sand, steel sand, alloy sand, and copper ore.

The carrier 30 can be made of rubber or resin.

The rubber can be selected from a group consisting of silicon rubber, natural rubber (NR), styrene-butadiene rubber (SBR), chloroprene rubber (CR), isobutylene-isoprene rubber (IIIR), nitrile butadiene rubber (NBR), cis-1,4-polybutadiene rubber (BR), isoprene rubber (IR), ethylene-propylene-diene monomer (EPDM), chlorosulfonated polyethylene (CSM), chlorobutyl rubber (CIIR), polysulfide rubber (PSR), acrylate rubber (ACM), polyurethane rubber (PUR), chlorohydrin rubber (CO), and fluororubber (FKM).

The resin can be selected from a group consisting of thermoplastic urethane (TPU), polyvinyl chloride (PVC), ethylene-vinyl acetate copolymer (EVA), polyolyaltha olfin (POE), thermoplastic elastomers (TPES), polyethylene (PE), and polypropylene (PP).

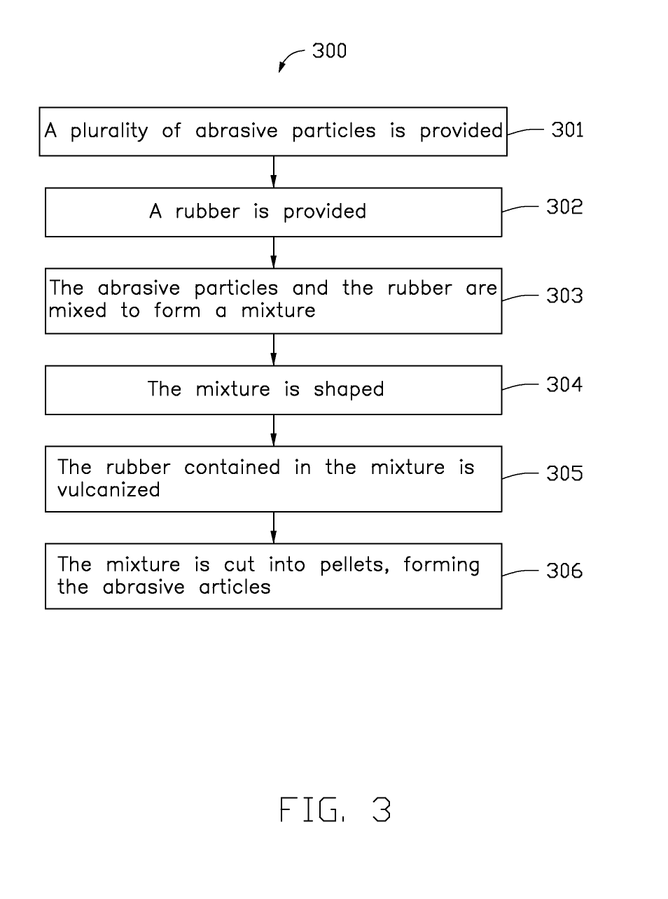

Referring to FIG. 3, a flowchart is presented in accordance with a first exemplary embodiment. The method 300 is provided by way of example, as there are a variety of ways to carry out the method. The method 300 described below can be carried out using the configurations illustrated in FIGS. 1-2, for example, and various elements of these figures are referenced in explaining example method 300. Each block shown in FIG. 3 represents one or more processes, methods, or subroutines carried out in the method 300. Furthermore, the order of blocks is illustrative only and the order of the blocks can change. Additional blocks can be added or fewer blocks can be utilized, without departing from this disclosure. The method 300 can begin at block 301.

At block 301, a plurality of abrasive particles 10 is provided. The abrasive particles 10 can be selected from a group consisting of alumina sand, white fused alumina sand, brown alumina sand, emery, carborundum sand, steel sand, alloy sand, and copper ore.

At block 302, a rubber is provided. The rubber can be selected from a group consisting of silicon rubber, natural rubber (NR), styrene-butadiene rubber (SBR), chloroprene rubber (CR), isobutylene-isoprene rubber (IIIR), nitrile butadiene rubber (NBR), cis-1,4-polybutadiene rubber (BR), isoprene rubber (IR), ethylene-propylene-diene monomer (EPDM), chlorosulfonated polyethylene (CSM), chlorobutyl rubber (CIIR), polysulfide rubber (PSR), acrylate rubber(ACM), polyurethane rubber (PUR), chlorohydrin rubber (CO), and fluororubber (FKM).

At block 303, the rubber and the abrasive particles 10 can be mixed in a Banbury mixer or an open mill. A mass ratio of the abrasive particles 10 to the rubber can be about 1:1 to about 5:1.

At block 304, the mixture of the abrasive particles 10 and the rubber is shaped through an extruding machine, a molding machine, or a calender. In an exemplary embodiment, the mixture is extruded into a wire shape.

At block 305, the rubber contained in the mixture is vulcanized by a vulcanizing machine, such the rubber can have good flexibility. The vulcanization process includes heating the mixture at a temperature of about 120° C. for about 10 minutes.

At block 306, the vulcanized mixture is cut into pellets by a granulator, forming the abrasive articles 100. In at least one exemplary embodiment, the abrasive articles 100 are ball shaped, and have a diameter of between about 0.2 mm to about 1.0 mm. Each abrasive article 100 includes a plurality of abrasive particles 10 and a carrier 30 made of rubber, the abrasive particles 10 can be disposed on or in the carrier 30.

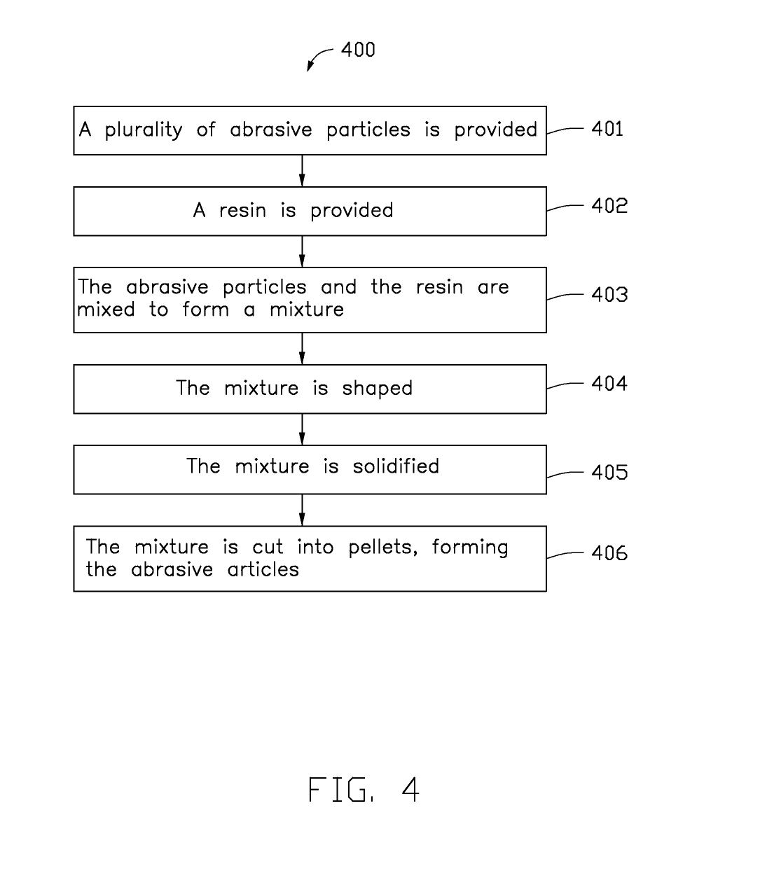

Referring to FIG. 4, a flowchart is presented in accordance with a second example embodiment. The method 400 is provided by way of example, as there are a variety of ways to carry out the method. The method 400 described below can be carried out using the configurations illustrated in FIGS. 1-2, for example, and various elements of these figures are referenced in explaining method 400. Each block shown in FIG. 4 represents one or more processes, methods, or subroutines, carried out in the method 400. Furthermore, the illustrated order of blocks is illustrative only and the order of the blocks can change. Additional blocks may be added or fewer blocks may be utilized, without departing from this disclosure. The method 400 can begin at block 401.

At block 401, a plurality of abrasive particles 10 is provided. The abrasive particles 10 can be selected from a group consisting of alumina sand, white fused alumina sand, brown alumina sand, emery, carborundum sand, steel sand, alloy sand, and copper ore.

At block 402, a resin is provided. The resin can be selected from a group consisting of thermoplastic urethane (TPU), polyvinyl chloride (PVC), ethylene-vinyl acetate copolymer (EVA), polyolyaltha olfin (POE), thermoplastic elastomers (TPES), polyethylene (PE), and polypropylene (PP).

At block 403, the resin and the abrasive particles 10 are mixed in a Banbury mixer or an open mill. A mass ratio of the abrasive particles 10 to the resin can be about 1:1 to about 5:1.

At block 404, the mixture is put into a grit maker having a screw, the resin contained in the mixture can be heated until the resin is melted to a fluid state, the melted resin can be completely mixed with the abrasive particles 10 through a rotation of the screw. Then the mixture can be pressed or extruded into a desired shape, such as a wire shape.

At block 405, the shaped mixture is solidified with cold water.

At block 406, the mixture is cut into pellets, forming the abrasive articles 100. In at least one exemplary embodiment, the abrasive articles 100 are ball shaped, and have a diameter of between about 0.2 mm to about 1.0 mm. Each abrasive article 100 includes a plurality of abrasive particles 10 and a carrier 30 made of resin, the abrasive particles 10 can be disposed in or on the carrier 30.

The abrasive articles 100 are formed by cutting the mixture of the abrasive particles 10 and the carrier 30 into pellets, such the abrasive articles 100 not only have the abrasive qualities of the abrasive particles 10, but also have the flexibility and damping qualities of the carrier 30. When the abrasive articles 100 are being blasted onto a surface of a product (not shown), the abrasive articles 100 can remove a defect of the product, but as the carrier 30 is elastic, the carrier 30 can also protect the product from damaged.

It is to be understood, however, that even through numerous characteristics and advantages of the present disclosure have been set forth in the foregoing description, together with details of assembly and function, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. An abrasive article comprising:
a carrier being made of resin or rubber; and
a plurality of abrasive particles being disposed in or on the carrier, a mass ratio of abrasive particles to carrier being about 1:1 to about 5:1.

2. The abrasive article claimed in claim 1, wherein the abrasive particles are selected from a group consisting of alumina sand, white fused alumina sand, brown alumina sand, emery, carborundum sand, steel sand, alloy sand and copper ore.

3. The abrasive article claimed in claim 1, wherein the abrasive particles have a diameter of between about 0.2 mm to about 1.0 mm.

4. The abrasive article claimed in claim 1, wherein the rubber is selected from a group consisting of silicon rubber, natural rubber, styrene-butadiene rubber, chloroprene rubber, isobutylene-isoprene rubber, nitrile butadiene rubber, cis-1,4-polybutadiene rubber, isoprene rubber, ethylene-propylene-diene monomer, chlorosulfonated polyethylene, chlorobutyl rubber, polysulfide rubber, acrylate rubber, polyurethane rubber, chlorohydrin rubber and fluororubber.

5. The abrasive article claimed in claim 1, wherein the resin is selected from a group consisting of thermoplastic urethane polyvinyl chloride, ethylene-vinyl acetate copolymer, polyolyaltha olfin, thermoplastic elastomers, polyethylene and polypropylene.

6. A method for making abrasive articles, comprising:
providing a plurality of abrasive particles;
providing a rubber;
mixing the rubber and the abrasive particles, a mass ratio of abrasive particles to carrier being about 1:1 to about 5:1;
shaping the mixture;
vulcanizing the rubber contained in the mixture; and
cutting the vulcanized mixture into pellets, forming the abrasive articles.

7. The method as claimed in claim 6, wherein the rubber is vulcanized at a temperature of about 120° C. for about 10 minutes.

8. The method as claimed in claim 6, wherein the abrasive particles have a diameter of between about 0.2 mm to about 1.0 mm.

9. The method as claimed in claim 7, wherein the abrasive particles are selected from a group consisting of alumina sand, white fused alumina sand, brown alumina sand, emery, carborundum sand, steel sand, alloy sand and copper ore.

10. The method as claimed in claim 6, wherein the rubber is selected from a group consisting of silicon rubber, natural rubber, styrene-butadiene rubber, chloroprene rubber, isobutylene-isoprene rubber, nitrile butadiene rubber, cis-1,4-polybutadiene rubber, isoprene rubber, ethylene-propylene-diene monomer, chlorosulfonated polyethylene, chlorobutyl rubber, polysulfide rubber, acrylate rubber, polyurethane rubber, chlorohydrin rubber and fluororubber.

11. A method for making abrasive articles, comprising:
providing a plurality of abrasive particles;
providing a resin;
mixing the rubber and the abrasive particles, a mass ratio of abrasive particles to carrier being about 1:1 to about 5:1;
heating the mixture to a fluid state, and pressing the mixture to form into a desired shape;
cooling the mixture; and
cutting the mixture into pellets, forming the abrasive articles.

12. The method as claimed in claim 11, wherein the abrasive particles have a diameter of between about 0.2 mm to about 1.0 mm.

13. The method as claimed in claim 11, wherein the abrasive particles are selected from a group consisting of alumina sand, white fused alumina sand, brown alumina sand, emery, carborundum sand, steel sand, alloy sand and copper ore.

14. The method as claimed in claim 11, wherein the resin is selected from a group consisting of thermoplastic urethane polyvinyl chloride, ethylene-vinyl acetate copolymer, polyolyaltha olfin, thermoplastic elastomers, polyethylene and polypropylene.
